(19) United States
(12) Patent Application Publication
(10) Pub. No.: US 2020/0130735 A1
(43) Pub. Date: Apr. 30, 2020

(54) STEERING CONTROL METHOD AND SYSTEM FOR REAR-WHEEL STEERING

(71) Applicants: HYUNDAI MOTOR COMPANY, Seoul (KR); KIA MOTORS CORPORATION, Seoul (KR); IUCF-HYU (Industry-University Cooperation Foundation Hanyang University), Seoul (KR)

(72) Inventors: Rae Wook Chung, Suwon-si (KR); Jun Wook Oh, Seoul (KR); Jun Haeng Heo, Yangpyeong-gun (KR); Seung Ki Kim, Hwaseong-si (KR); Kun Soo Huh, Seoul (KR); Jang Hee Park, Seoul (KR)

(21) Appl. No.: 16/267,602

(22) Filed: Feb. 5, 2019

(30) Foreign Application Priority Data
Oct. 25, 2018 (KR) 10-2018-0128113

(51) Int. Cl. B62D 6/00; B62D 15/02

(52) U.S. Cl. CPC B62D 6/005; B60W 40/114; B62D 15/021

(57) ABSTRACT

The present disclosure provides a steering control method and system for rear-wheel steering that improves driving stability and yaw responsiveness of a vehicle by controlling rear wheels on the basis of a driving state of a vehicle. The method and system receives a vehicle speed and a front-wheel turning angle and calculates a rear-wheel same/inverse-phase control amount; estimates tire slip angles when the vehicle is driven such that the rear wheels are controlled with the same phase; calculates a final rear-wheel turn control value by reflecting a control weight proportioned to the tire slip angle estimation value to the rear-wheel same-phase control amount; and turns the rear wheels on the basis of the final rear-wheel turn control value.

### CROSS REFERENCE TO RELATED APPLICATION

The present application claims priority to Korean Patent Application No. 10-2018-0128113, filed Oct. 25, 2018, the entire contents of which are incorporated herein for all purposes by this reference.

### BACKGROUND

### 1. Field of the invention

The present disclosure relates to a steering control method and system for rear-wheel steering, the method and system improving driving stability and yaw responsiveness of a vehicle by controlling rear wheels in consideration of the driving state of the vehicle.

### 2. Description of the Prior Art

4-wheel steering (4WS), in which steering is performed using both front wheels and rear wheels, can reduce a turning radius and considerably improve turning stability compared with 2-wheel steering (2WS).

Accordingly, 4WS reduces a turning radius by controlling the turning angle of rear wheels with an inverse phase, which is the direction opposite the turning angle of the front wheels, at low speeds, and improves turning stability by controlling the turning angle of rear wheels with the same phase, that is, the same direction as the turning angle of front wheels, at high speeds.

However, when the rear wheels are turned with the same phase at high speeds, it is possible to increase driving stability by suppressing transverse sliding of a car body, but the rear wheels and the front wheels are turned in the same direction, so yaw responsiveness is deteriorated and turn-in ability is correspondingly deteriorated.

A control function that decreases a same-phase control amount or delays same-phase control, depending on the state of steering performed by a driver, is added to solve this problem, but control is performed only through steering input by a driver in this method, so control suitable for the driving state of a vehicle is not achieved.

The description provided above as a related art of the present disclosure is just for helping understanding the background of the present disclosure and should not be construed as being included in the related art known by those skilled in the art.

### SUMMARY

The present disclosure has been made in order to solve the above-mentioned problems with the prior art, and an aspect of the present disclosure is to provide a steering control method and system for rear-wheel steering, the method and system improving the driving stability and yaw responsiveness of a vehicle by controlling rear wheels in consideration of the driving state of the vehicle.

In view of the above aspect, a steering control method for rear-wheel steering according to the present disclosure may include: a calculation step in which a controller receives a vehicle speed and a front-wheel turning angle and calculates a rear-wheel same/inverse-phase control amount; an estimation step in which the controller estimates tire slip angles on the basis of factors showing a driving state of a vehicle when the vehicle is driven such that the rear wheels are controlled with the same phase; a compensation step in which the controller calculates a final rear-wheel turn control value by reflecting a control weight proportioned to the tire slip angle estimation value to the rear-wheel same-phase control amount; and a rear-wheel control step in which the controller turns the rear wheels by controlling a rear-wheel turn actuator on the basis of the final rear-wheel turn control value.

The estimation step may include: a step of receiving a vehicle speed, front-/rear-wheel turning angles, a yaw rate, a longitudinal acceleration, and a transverse acceleration; a step of calculating and estimating a transverse slip angle of a car body using the input factors; and a step of calculating and estimating tire slip angles using the factors and a transverse slip angle estimation value of the car body.

The compensation step may include: a step of determining a control weight in accordance with the tire slip angle estimation value; and a step of calculating a final rear-wheel turn control value by multiplying the rear-wheel same-phase control amount by the control weight.

The control weight may be a value satisfying 0<control weight≤1 and may be determined in proportion to the estimated tire slip angle.

Another aspect of the present disclosure is to provide a steering control method for rear-wheel steering, the method including: a calculation step in which a controller receives a vehicle speed and a front-wheel turning angle and calculates a rear-wheel same/inverse-phase control amount; an estimation step in which the controller estimates tire slip angles on the basis of factors showing a driving state of a vehicle; a compensation step in which the controller calculates a final rear-wheel turn control value by reflecting a control weight proportioned to the tire slip angle estimation value to the rear-wheel same-phase control amount; and a rear-wheel control step in which the controller turns the rear wheels by controlling a rear-wheel turn actuator on the basis of the final rear-wheel turn control value.

Another aspect of the present disclosure is to provide a steering control system for rear-wheel steering, the system including: a same/inverse-phase control amount calculator that receives a vehicle speed and a front-wheel turning angle and calculates a rear-wheel same/inverse-phase control amount; a vehicle state estimator that estimates tire slip angles on the basis of factors showing a driving state of a vehicle when the vehicle is driven such that the rear wheels are controlled with the same phase; and a rear-wheel turn controller that calculates a final rear-wheel turn control value by reflecting a control weight proportioned to the tire slip angle estimation value to the rear-wheel same-phase control amount and turns the rear wheels by controlling a rear-wheel turn actuator on the basis of the final rear-wheel turn control value.

The vehicle state estimator may include: a transverse slip angle estimator that receives a vehicle speed, front-/rear-wheel turning angles, a yaw rate, a longitudinal acceleration, and a transverse acceleration, and calculates and estimates a transverse slip angle of a car body using the input factors; and a tire slip angle estimator that calculates and estimates tire slip angles using the factors and a transverse slip angle estimation value of the car body.

The system may further include a distribution controller that determines a control weight in accordance with the tire slip angle estimation value, and the rear-wheel turn controller may calculate a final rear-wheel turn control value by multiplying the rear-wheel same-phase control amount by the control weight.

According to the present disclosure, the yaw responsiveness is increased by reducing the rear-wheel same-phase control amount in a region in which a tire slip angle is small when a vehicle is driven at a high speed, and the driving stability is increased by increasing the rear-wheel same-phase control amount in a region in which a tire slip angle is large. Therefore, it is possible to improve driving performance of the vehicle by appropriately controlling the rear wheels in accordance with the driving state of the vehicle.

### BRIEF DESCRIPTION OF THE DRAWINGS

The above and other aspects, features and advantages of the present disclosure will be more apparent from the following detailed description taken in conjunction with the accompanying drawings, in which:

FIG. 1 is a diagram schematically showing the configuration of a steering control system for rear-wheel steering according to the present disclosure;

FIG. 2 is a diagram showing meaning of variables in an equation for calculating a transverse slip angle and a tire slip angle according to the present disclosure;

FIG. 3 is a diagram showing a stability control weight according to a tire slip angle according to the present disclosure; and

FIG. 4 is a flowchart sequentially showing a rear-wheel steering process according to the present disclosure.

### DETAILED DESCRIPTION

Exemplary embodiments of the present disclosure are described hereafter in detail with reference to the accompanying drawings.

A steering control system for rear-wheel steering of the present disclosure, in a broad sense, includes a same/inverse-phase control amount calculator 1, a vehicle state estimator 3, a rear-wheel turn controller 11, and a rear-wheel turn actuator 13.

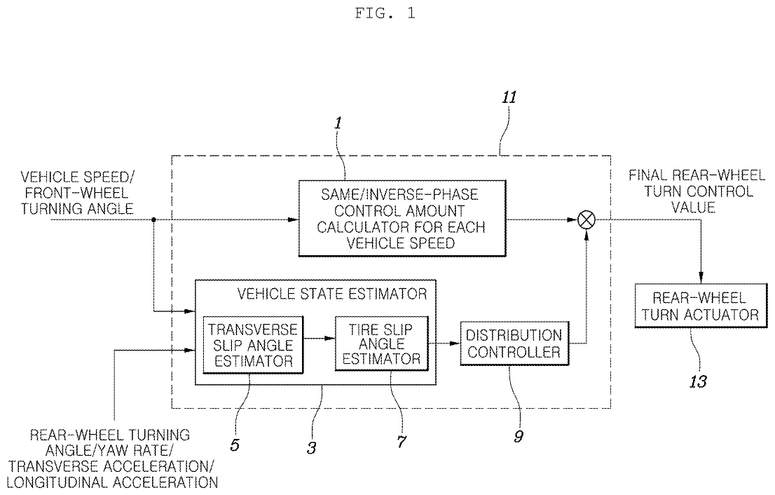

The present disclosure is described in detail with reference to FIG. 1. First, the same/opposite-phase control amount calculator 1 receives a vehicle speed and a front-wheel turning angle and calculates a rear-wheel same/inverse-phase control amount on the basis of the received vehicle speed and front-wheel turning angle.

For example, the vehicle speed can be received through a vehicle speed sensor and the front-wheel turning angle can be received through a steering angle sensor of a steering system. Rear wheels are controlled with an inverse phase at low speeds and with the same phase at high speeds, and the magnitude of a same/inverse control amount is calculated in proportion to the front-wheel turning angle.

The vehicle state estimator 3 estimates a tire slip angle on the basis of factors showing the driving state of a vehicle when the rear wheels of the vehicle are controlled with the same phase.

That is, when a vehicle is driven at a high speed, the rear wheels and the front wheels are controlled with the same phase, and in this process, slip angles of tires are calculated and estimated.

The rear-wheel turn controller 11 calculates a final rear-wheel turn control value by reflecting a control weight, which is proportioned to an estimated tire slip angle to the rear-wheel same-phase control amount. Further, it turns the rear wheels by controlling the rear-wheel turn actuator 13 on the basis of the calculated final rear-wheel turn control value.

That is, when the tire slip angle is small, it is determined that the stability of the vehicle has been secured to some degree, and the rear-wheel same-phase control amount is decreased, thereby being able to increase yaw responsiveness. In contrast, when the tire slip angle is large, it is determined that the stability of the vehicle is insufficient, and the rear-wheel same-phase control amount is increased, thereby being able to increase driving stability.

Accordingly, when a vehicle is driven at a high speed, it is possible to increase the yaw responsiveness or improve driving stability by controlling the rear wheels in accordance with the driving state of the vehicle.

The vehicle state estimator 3 includes a transverse slip angle estimator 5 that estimates a transverse slip angle and a tire slip angle estimator 7 that calculates a tire slip angle.

First, the transverse slip angle estimator 5 receives a vehicle speed, front/rear-wheel turning angles, a yaw rate, a longitudinal acceleration, and a transverse acceleration and calculates and estimates a transverse slip angle of the car body using the input factors. The factors are measured by sensors that can measure them and the measured signals can be input to the transverse slip angle estimator 5.

The tire slip angle estimator 7 can calculate and estimate tire slip angles using the factors and the transverse slip angle estimation value of the car body.

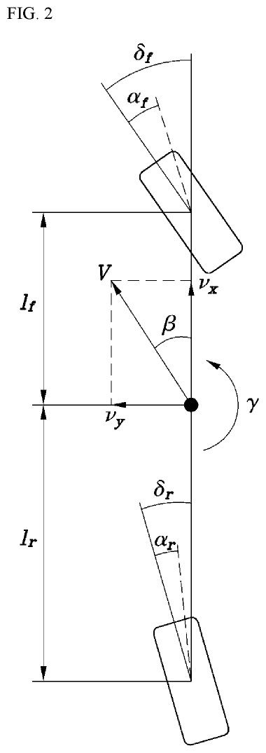

The transverse slip angle can be calculated through the following Equation (1) and the meanings of the variable in Equation (1) are shown in FIG. 2.

\hat{β}=p₁·δ_{f}+p₂·δᵣ+p₃·γ+p₄·α (1)

p₁˜p₄ can be expressed as in the following Equation (2).

$${p}_{1} = \frac{{l}_{r} \cdot g - h \cdot {a}_{x}}{( {l}_{f} + {l}_{r} ) \cdot g} , {p}_{2} = \frac{h \cdot {a}_{x}}{{v}_{x} \cdot g} , {p}_{3} = \frac{{l}_{f} \cdot g + h \cdot {a}_{x}}{( {l}_{f} + {l}_{r} ) \cdot g} , {p}_{4} = \frac{- 1}{{K}_{t} \cdot g} \qquad ( 2 )$$

In variables not shown in FIG. 2, g is acceleration due to gravity, h is the height of the center of gravity of a vehicle, aₓ is a longitudinal acceleration, a_{y} is a transverse acceleration, and Kₜ is an understeer gradient.

For reference, in the above equation, h, l_{f}, and Kₜ can be determined through an optimization technique in order to secure appropriate performance of the transverse slip angle estimator 5. That is, it is possible to determine optimal h, l_{f}, and Kₜ by comparing an actually measured transverse slip angle with a transverse slip angle calculated using the Equations, and these parameters can be determined before a controller is actually configured and can then be taken into consideration by the controller.

The tire slip angle can be obtained using the transverse slip angle estimation value calculated by the transverse slip angle estimator 5, and it is possible to calculate tire slip angles of front wheels and rear wheels through the following Equation (3) and secure a tire slip angle estimation value by averaging the tire slip angles.

$${\hat{α}}_{f} = {δ}_{f} - \hat{β} - \frac{{l}_{f} γ}{{v}_{x}} \\ {\hat{α}}_{r} = {δ}_{r} - \hat{β} + \frac{{l}_{r} γ}{{v}_{x}} \qquad ( 3 )$$

For reference, Equation (3) is induced from relations of automotive dynamics, and the tire slip angles may be estimated using other methods or equations devised by modifying the equation.

The system of the present disclosure further includes a distribution controller 9 that determines a control weight in accordance with the tire slip angle estimation value.

The rear-wheel turn controller 11 calculates a final rear-wheel turn control value by multiplying the rear-wheel same-phase control amount by the control weight.

According to a method of determining the control weight, the tire slip angle estimation value is input to the distribution controller 9 and the distribution controller 9 determines a stability control weight on the basis of the input tire slip angle estimation value.

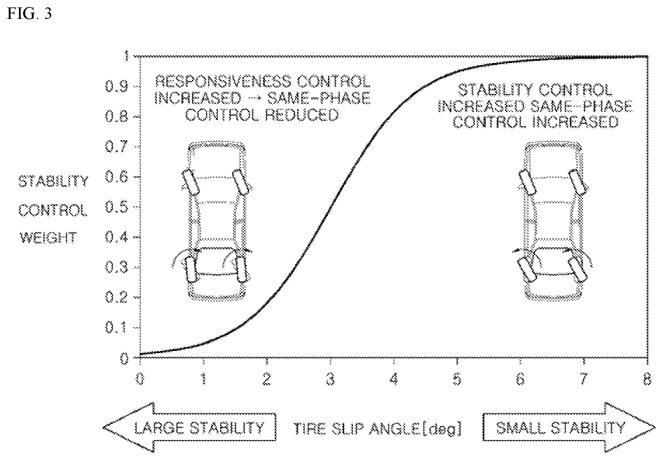

The control weight, as shown in FIG. 3, is shown in a curve shape that is continuously increased from 0 to 1 as a tire slip angle is increased and this curve can be expressed as Sigmoid function of the following Equation (4).

$$w = \frac{1}{1 + {e}^{- a ( \vert α \vert - b )}} \qquad ( 4 )$$

The parameter a in Equation (4) is a parameter that changes the slope of the function and changes the increasing speed of a control amount and the parameter b is a parameter that moves the function in the x-axial direction and changes a control start time point.

In FIG. 3, the X-axis represents a tire slip angle and the Y-axis represents a stability control weight.

Meanwhile, a steering control method for rear-wheel steering according to the present disclosure can be applied to high-speed driving in which rear wheels are controlled with the same phase, and includes a calculation step, an estimation step, a compensation step, and a rear-wheel control step.

Referring to FIG. 1, first, in the calculation step through the same/opposite-phase control amount calculator 1, a controller receives a vehicle speed and a front-wheel turning angle and calculates a rear-wheel same/inverse-phase control amount.

In the estimation step through the vehicle state estimator 3, the controller estimates tire slip angles on the basis of factors showing the driving state of a vehicle when the vehicle is driven such that the rear wheels are controlled with the same phase.

For example, the controller receives the speed of a vehicle, the turning angles of front/rear wheels, a yaw rate, a longitudinal acceleration, and a transverse acceleration and calculates and estimates the transverse slip angle of the car body using the input factors. Further, the controller calculates and estimates tire slip angles using the factors and the transverse slip angle estimation value of the car body.

In the compensation step, the controller calculates a final rear-wheel turn control value by reflecting a control weight proportioned to the tire slip angle estimation value to the rear-wheel same-phase control amount.

For example, the controller determines the control weight in accordance with the tire slip angle estimation value and calculates the final rear-wheel turn control value by multiplying the rear-wheel same-phase control amount by the control weight.

The control weight is a value satisfying 0<control weight≤1 and can be determined in proportion to the tire slip angle estimation value.

In the rear-wheel control step, the controller turns the rear wheels by controlling the rear-wheel turn actuator 13 on the basis of the final rear-wheel turn control value.

The controller may be the rear-wheel turn controller 11 that controls and turns rear wheels and can perform the steps through the same/inverse-phase control amount calculator 1, the vehicle state estimator 3, and the distribution controller 9 provided in the rear-wheel turn controller 11.

According to another embodiment, the steering control method for rear-wheel steering of the present disclosure may be applied not only when a vehicle is driven at a high speed in which rear wheels are controlled with the same phase, but also when a vehicle is driven at a low speed in which rear wheels are controlled with an inverse phase.

To this end, the method may include a calculation step in which a controller receives a vehicle speed and a front-wheel turning angle and calculates a rear-wheel same-phase control amount, an estimation step in which the controller estimates tire slip angles on the basis of factors showing the driving state of a vehicle; a compensation step in which the controller calculates a final rear-wheel turn control value by reflecting a control weight proportioned to a tire slip angle estimation value to the rear-wheel same-phase control amount, and a rear-wheel control step in which the controller turns rear wheels by controlling the rear-wheel turn actuator 13 on the basis of the final rear-wheel turn control value.

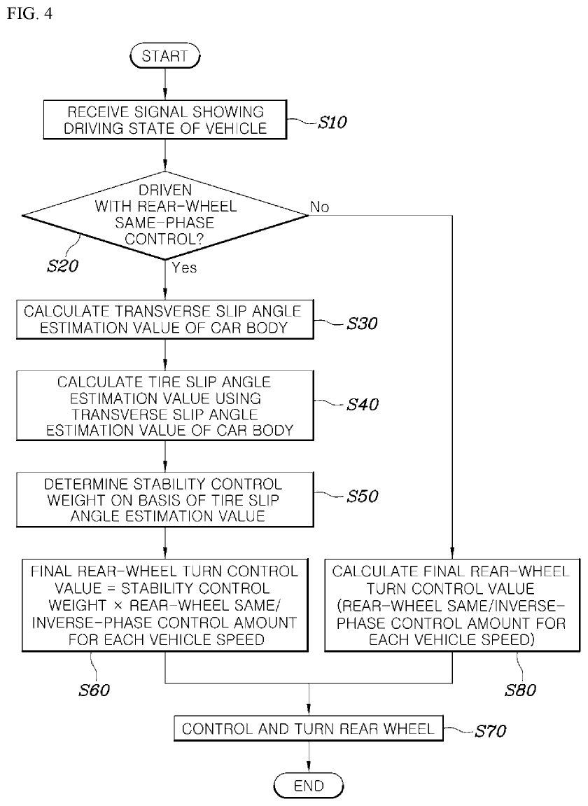

The steering control process for rear wheel according to the present disclosure is sequentially described with reference to FIG. 4. A rear-wheel turning angle, a yaw rate, a longitudinal acceleration, and a transverse acceleration are measured together with a vehicle speed and a front-wheel turning angle for controlling rear wheels (S10).

Next, it is determined whether the vehicle is driven at a high speed in which the rear wheels are controlled with the same phase (S20) and a transverse slip angle estimation value of a car body is calculated when the rear wheels are controlled with the same phase as the result of the determination (S30).

A tire slip angle estimation value is calculated using the transverse slip angle estimation value (S40).

Next, a stability control weight is determined on the basis of the tire slip angle estimation value, in which the control weight increases as the tire slip angle estimation value is small, and decreases as the tire slip angle estimation value is large (S50).

Next, a final rear-wheel turn control value is calculated by multiplying a rear-wheel same-phase control amount for each vehicle speed by the control weight (S60).

Further, the rear wheels are controlled and turned by operating rear-wheel turn actuator on the basis of the final rear-wheel turn control value (S70).

However, when the rear wheels are controlled with an inverse phase as the result of step S20, the rear-wheel same-phase control amount for each vehicle speed is determined as the final rear-wheel turn control value without reflecting the control weight (S80) and the rear wheels can be controlled and turned on the basis of the determined final rear-wheel turn control value.

As described above, according to the present disclosure, the yaw responsiveness is increased by reducing the rear-wheel same-phase control amount in a region in which a tire slip angle is small when a vehicle is driven at a high speed, and the driving stability is increased by increasing the rear-wheel same-phase control amount in a region in which a tire slip angle is large.

Accordingly, when a vehicle is driven at a high speed, it is possible to increase the yaw responsiveness or improve the driving stability of a vehicle by appropriately controlling the rear wheels in accordance with the driving state of the vehicle.

On the other hand, although the present disclosure was described with reference to the detailed embodiments, it will be apparent to those skilled in the art that the present disclosure may be changed and modified in various ways without departing from the scope of the present disclosure and it should be noted that the changes and modifications are included in claims.

While a number of exemplary aspects have been discussed above, those of skill in the art will recognize that still further modifications, permutations, additions and sub-combinations thereof of the disclosed features are still possible. It is therefore intended that the following appended claims and claims hereafter introduced are interpreted to include all such modifications, permutations, additions and sub-combinations as are within their true spirit and scope.

1. A steering control method for rear-wheel steering, the method comprising:
a calculation step in which a controller receives a vehicle speed and a front-wheel turning angle and calculates a rear-wheel same/inverse-phase control amount;
an estimation step in which the controller estimates tire slip angles on the basis of factors showing a driving state of a vehicle when the vehicle is driven such that the rear wheels are controlled with the same phase;
a compensation step in which the controller calculates a final rear-wheel turn control value by reflecting a control weight proportioned to the tire slip angle estimation value to the rear-wheel same-phase control amount; and
a rear-wheel control step in which the controller turns the rear wheels by controlling a rear-wheel turn actuator on the basis of the final rear-wheel turn control value.

2. The method of claim 1, wherein the estimation step includes:
a step of receiving a vehicle speed, front-/rear-wheel turning angles, a yaw rate, a longitudinal acceleration, and a transverse acceleration;
a step of calculating and estimating a transverse slip angle of a car body using the input factors; and
a step of calculating and estimating tire slip angles using the factors and a transverse slip angle estimation value of the car body.

3. The method of claim 1, wherein the compensation step includes:
a step of determining a control weight in accordance with the tire slip angle estimation value; and
a step of calculating a final rear-wheel turn control value by multiplying the rear-wheel same-phase control amount by the control weight.

4. The method of claim 3, wherein the control weight is a value satisfying 0<control weight≤1 and is determined in proportion to the tire slip angle estimation value.

5. A steering control method for rear-wheel steering, the method comprising:
a calculation step in which a controller receives a vehicle speed and a front-wheel turning angle and calculates a rear-wheel same/inverse-phase control amount;
an estimation step in which the controller estimates tire slip angles on the basis of factors showing a driving state of a vehicle;
a compensation step in which the controller calculates a final rear-wheel turn control value by reflecting a control weight proportioned to a tire slip angle estimation value to the rear-wheel same-phase control amount; and
a rear-wheel control step in which the controller turns the rear wheels by controlling a rear-wheel turn actuator on the basis of the final rear-wheel turn control value.

6. A steering control system for rear-wheel steering, the system comprising:
a same/inverse-phase control amount calculator that receives a vehicle speed and a front-wheel turning angle and calculates a rear-wheel same/inverse-phase control amount;
a vehicle state estimator that estimates tire slip angles on the basis of factors showing a driving state of a vehicle when the vehicle is driven such that the rear wheels are controlled with the same phase; and
a rear-wheel turn controller that calculates a final rear-wheel turn control value by reflecting a control weight proportioned to a tire slip angle estimation value to the rear-wheel same-phase control amount and turns the rear wheels by controlling a rear-wheel turn actuator on the basis of the final rear-wheel turn control value.

7. The system of claim 6, wherein the vehicle state estimator includes:
a transverse slip angle estimator that receives a vehicle speed, front-/rear-wheel turning angles, a yaw rate, a longitudinal acceleration, and a transverse acceleration, and calculates and estimates a transverse slip angle of a car body using the input factors; and
a tire slip angle estimator that calculates and estimates tire slip angles using the factors and a transverse slip angle estimation value of the car body.

8. The system of claim 6, further comprising a distribution controller that determines a control weight in accordance with the tire slip angle estimation value,
wherein the rear-wheel turn controller calculates a final rear-wheel turn control value by multiplying the rear-wheel same-phase control amount by the control weight.
